(19) United States
(12) Patent Application Publication
(10) Pub. No.: US 2026/0269494 A1
(43) Pub. Date: Sep. 10, 2026

(54) ELECTRICAL CONNECTOR AND CONNECTOR ASSEMBLY WITH IMPROVED SHIELDING CAVITY

(71) Applicant: DONGGUAN LUXSHARE TECHNOLOGIES CO., LTD, Dongguan City (CN)

(72) Inventors: Hengshan CHENG, Dongguan City (CN); Chuanqi GONG, Dongguan City (CN); Hongji CHEN, Dongguan City (CN)

(73) Assignee: DONGGUAN LUXSHARE TECHNOLOGIES CO., LTD, Dongguan City (CN)

(21) Appl. No.: 19/367,270

(22) Filed: Oct. 23, 2025

Related U.S. Application Data
(63) Continuation-in-part of application No. 19/327,494, filed on Sep. 12, 2025.

(30) Foreign Application Priority Data
Mar. 7, 2025 (CN) 202510274968.1
Jun. 30, 2025 (CN) 202510898224.7

(51) Int. Cl. H01R 12/70; H01R 13/6581

(52) U.S. Cl. CPC H01R 12/7047; H01R 13/6581

(57) ABSTRACT

An electrical connector includes a mounting frame, a shielding shell assembly, and a terminal module. The shielding shell assembly includes a first shielding plate assembly, a second shielding plate assembly, a third shielding plate assembly, and a fourth shielding plate assembly. The first shielding plate assembly is arranged opposite to the second shielding plate assembly. The third shielding plate assembly is arranged opposite to the fourth shielding plate assembly. Two ends of the first shielding plate assembly are respectively fixed to the third shielding plate assembly and the fourth shielding plate assembly. Two ends of the second shielding plate assembly are respectively fixed to the third shielding plate assembly and the fourth shielding plate assembly. The first shielding plate assembly, the second shielding plate assembly, the third shielding plate assembly, and the fourth shielding plate assembly jointly form a shielding unit to improve shielding effect.

### CROSS-REFERENCE TO RELATED APPLICATIONS

This patent application is a continuation-in-part of U.S. Application Ser. No. 19/327,494, filed on September 12, 2025 and titled “ELECTRICAL CONNECTOR AND CONNECTOR ASSEMBLY WITH IMPROVED SHIELDING ASSEMBLY”, and claims priority of a Chinese Patent Application No. 202510898224.7, filed on June 30, 2025 and titled “ELECTRICAL CONNECTOR AND CONNECTOR ASSEMBLY” and Chinese Patent Application No. 202510274968.1, filed on March 7, 2025 and titled “FIRST ELECTRICAL CONNECTOR AND CONNECTOR ASSEMBLY”. The entire contents of the aforementioned applications are incorporated herein by reference in their entirety.

### TECHNICAL FIELD

The present disclosure relates to an electrical connector and a connector assembly, belonging to the technical field of connectors.

### BACKGROUND

Connector assemblies in related art typically include an electrical connector and a mating connector that mates with the electrical connector. The electrical connector typically includes a shielding cavity. The mating connector typically includes a shielding shell that is inserted into the shielding cavity.

With the increasing demands for signal transmission, there is still room for improvement in the shielding structures of related art.

### SUMMARY

An embodiment of the present disclosure adopts the following technical solution: an electrical connector including: a mounting frame defining a mounting space; a shielding shell assembly at least partially received in the mounting space; the shielding shell assembly including a first shielding plate assembly, a second shielding plate assembly, a third shielding plate assembly, and a fourth shielding plate assembly; the first shielding plate assembly and the second shielding plate assembly being arranged opposite to each other; the third shielding plate assembly and the fourth shielding plate assembly being arranged opposite to each other; two ends of the first shielding plate assembly being coupled to the third shielding plate assembly and the fourth shielding plate assembly, respectively; two ends of the second shielding plate assembly are coupled to the third shielding plate assembly and the fourth shielding plate assembly, respectively; the first shielding plate assembly, the second shielding plate assembly, the third shielding plate assembly and the fourth shielding plate assembly jointly forming a shielding unit, and the shielding unit defining a shielding cavity; and a terminal module at least partially received in the shielding cavity, the terminal module including an insulating block, a first conductive terminal disposed on the insulating block, and a second conductive terminal disposed on the insulating block.

An embodiment of the present disclosure adopts the following technical solution: a connector assembly including: an electrical connector, the electrical connector including: a mounting frame defining a mounting space; a shielding shell assembly at least partially received in the mounting space; the shielding shell assembly including a first shielding plate assembly, a second shielding plate assembly, a third shielding plate assembly, and a fourth shielding plate assembly; the first shielding plate assembly and the second shielding plate assembly being arranged opposite to each other; the third shielding plate assembly and the fourth shielding plate assembly being arranged opposite to each other; two ends of the first shielding plate assembly being coupled to the third shielding plate assembly and the fourth shielding plate assembly, respectively; two ends of the second shielding plate assembly are coupled to the third shielding plate assembly and the fourth shielding plate assembly, respectively; the first shielding plate assembly, the second shielding plate assembly, the third shielding plate assembly and the fourth shielding plate assembly jointly forming a shielding unit, and the shielding unit defining a shielding cavity; and a terminal module at least partially received in the shielding cavity, the terminal module including an insulating block, a first conductive terminal disposed on the insulating block, and a second conductive terminal disposed on the insulating block; and a mating connector, the mating connector including a cable module and a metal shield enclosure sleeved over the cable module; the metal shield enclosure being at least partially received in the shielding cavity; and the metal shield enclosure being in contact with at least one of the first shielding plate assembly, the second shielding plate assembly, the third shielding plate assembly, and the fourth shielding plate assembly.

### BRIEF DESCRIPTION OF DRAWINGS

FIG. 1 is a perspective schematic view of a connector assembly in accordance with an embodiment of the present disclosure;

FIG. 2 is a perspective schematic view of FIG. 1 from another angle;

FIG. 3 is a partial exploded perspective view of FIG. 1;

FIG. 4 is a further partial exploded perspective view of FIG. 3;

FIG. 5 is a perspective schematic view of an electrical connector in FIG. 4 from another angle;

FIG. 6 is a partial enlarged view of circled portion B in FIG. 5;

FIG. 7 is a top view of the electrical connector in FIG. 4 when separated from a circuit board;

FIG. 8 is a partial enlarged view of framed portion C in FIG. 7;

FIG. 9 is a partial exploded perspective view of the electrical connector in FIG. 4;

FIG. 10 is a partial enlarged view of circled portion D in FIG. 9;

FIG. 11 is a partial exploded perspective view of FIG. 9 from another angle;

FIG. 12 is an exploded perspective view of a mounting frame in FIG. 9;

FIG. 13 is an exploded perspective view of FIG. 12 from another angle;

FIG. 14 is a top view of the mounting frame in FIG. 9 when separated from a shielding module;

FIG. 15 is a partial enlarged view of framed portion E in FIG. 14;

FIG. 16 is a perspective schematic view of one shielding module in FIG. 9;

FIG. 17 is a partial exploded perspective view of FIG. 16;

FIG. 18 is an exploded perspective view of a first shielding assembly and a second shielding assembly in FIG. 17;

FIG. 19 is a perspective schematic view of FIG. 16 from another angle;

FIG. 20 is a partial exploded perspective view of FIG. 19;

FIG. 21 is an exploded perspective view of the first shielding assembly and the second shielding assembly in FIG. 20;

FIG. 22 is an exploded perspective view of a terminal module in FIG. 17;

FIG. 23 is an exploded perspective view of FIG. 22 from another angle;

FIG. 24 is a perspective schematic view of a mating connector in FIG. 4 from another angle; and

FIG. 25 is a cross-sectional schematic view taken along line F-F in FIG. 4.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

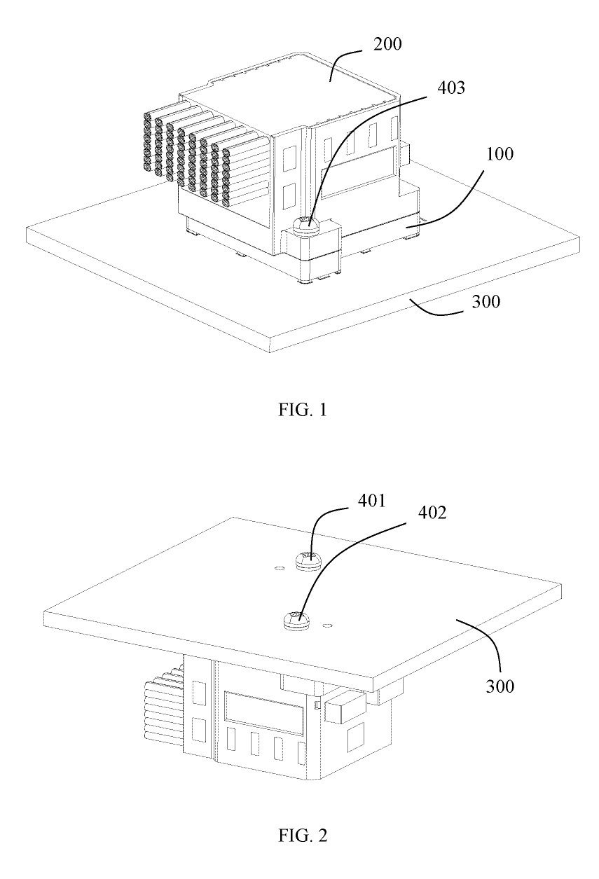

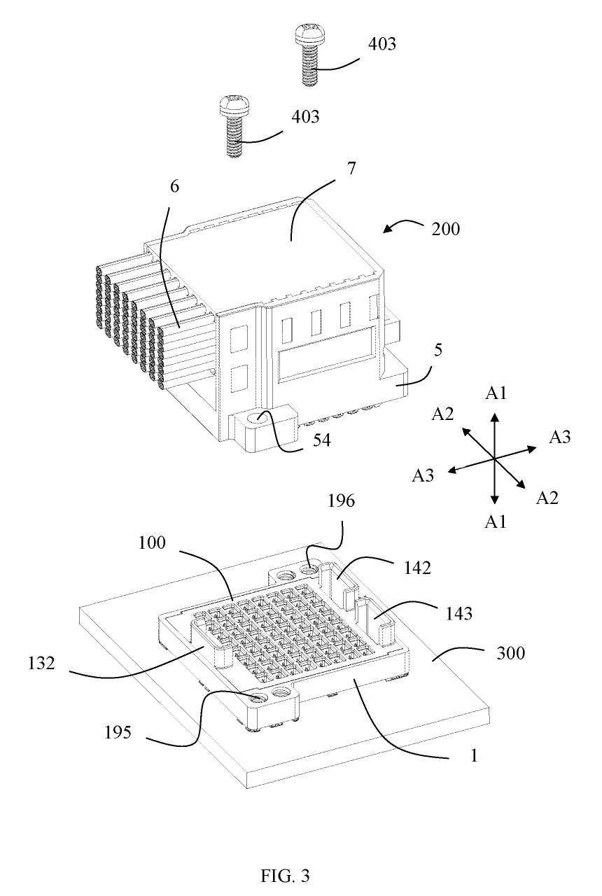

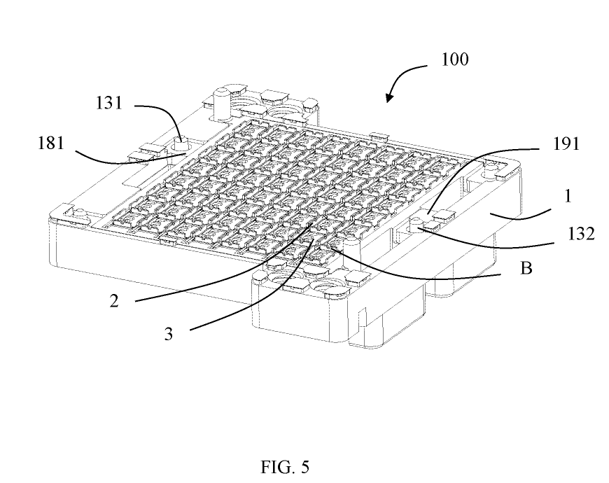

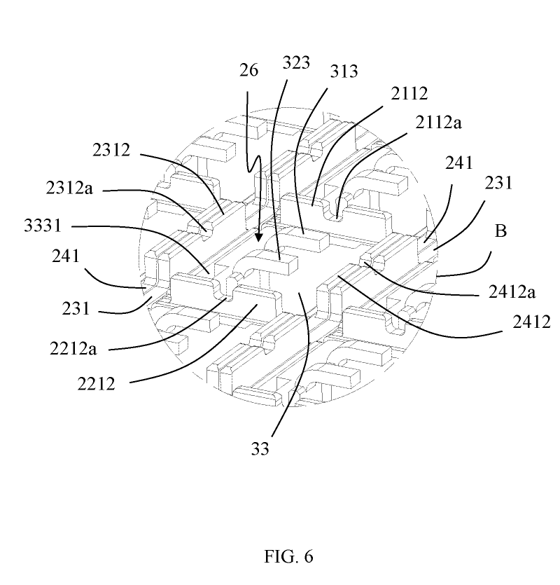

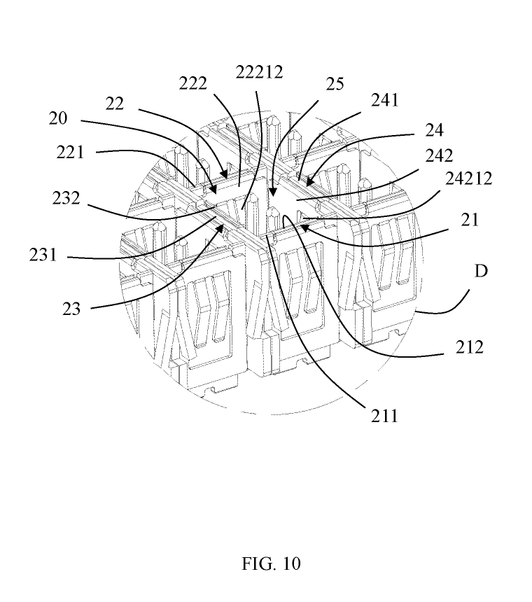

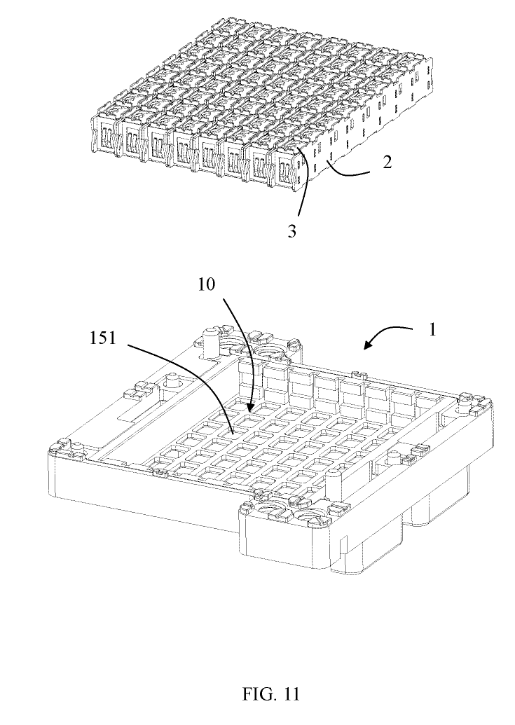

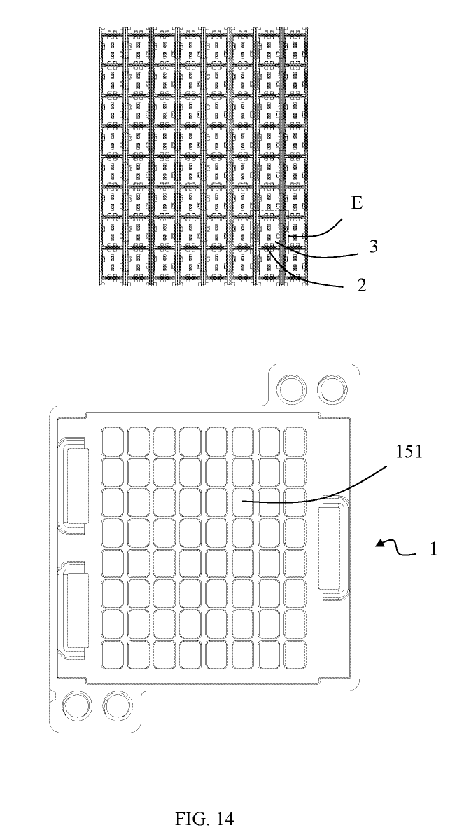

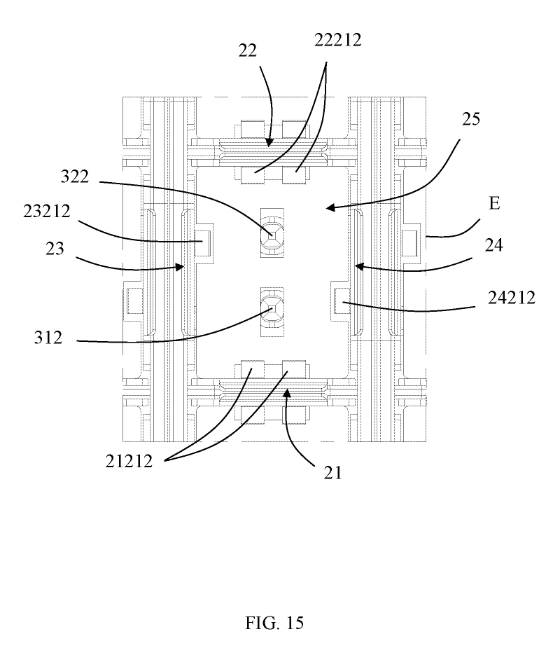

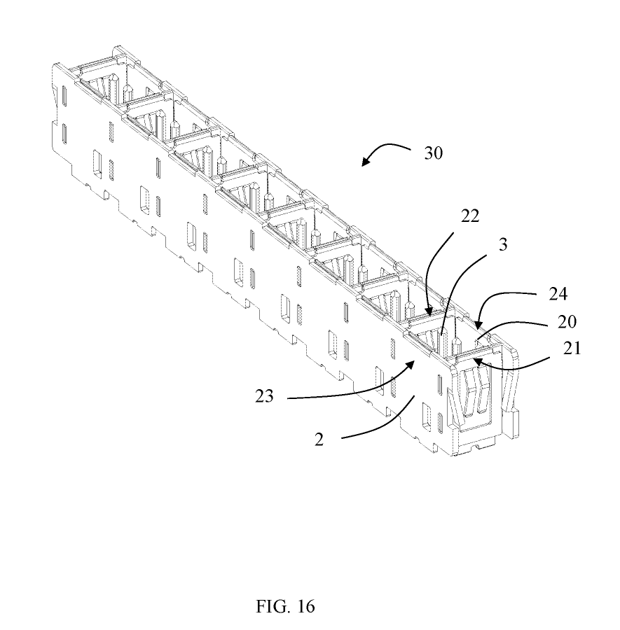

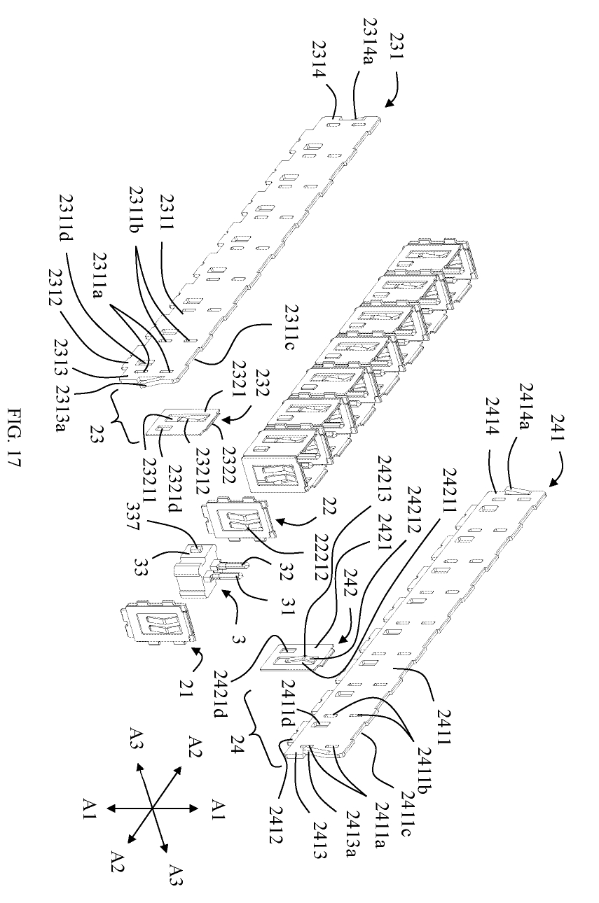

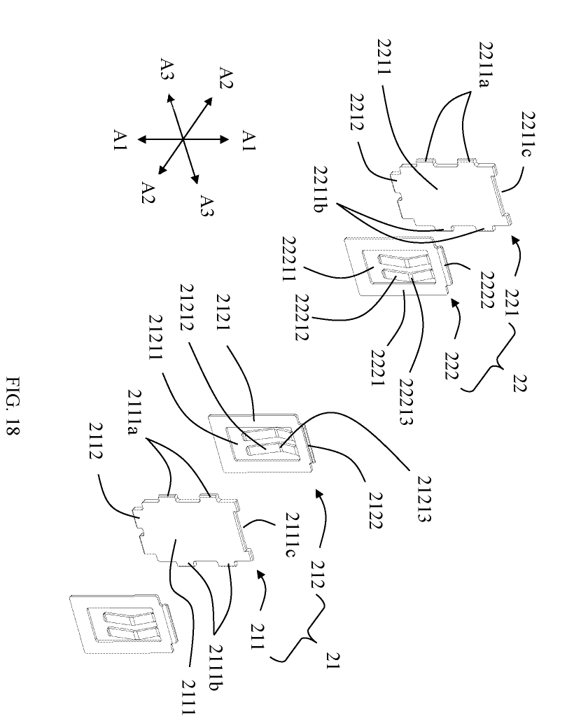

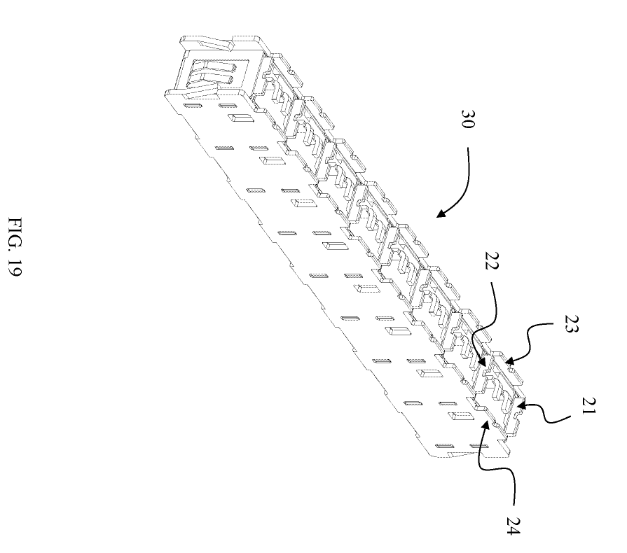

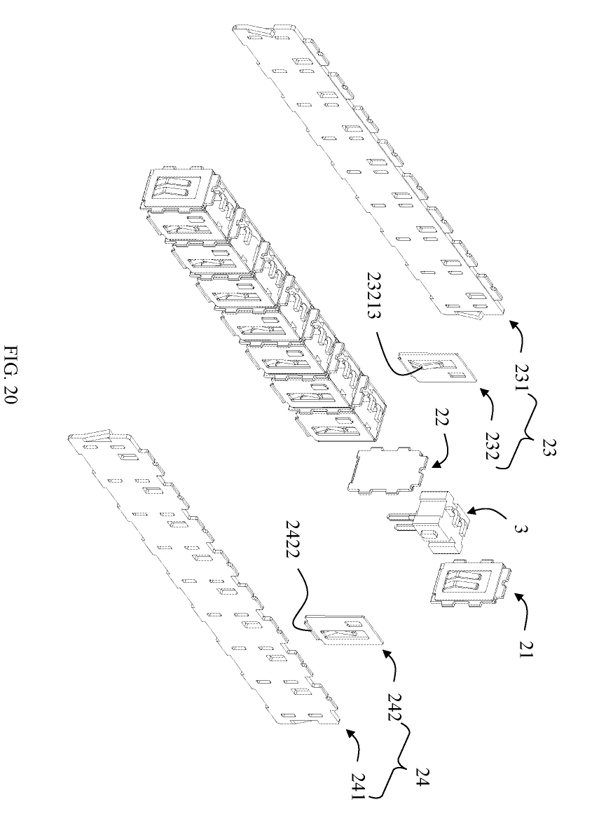

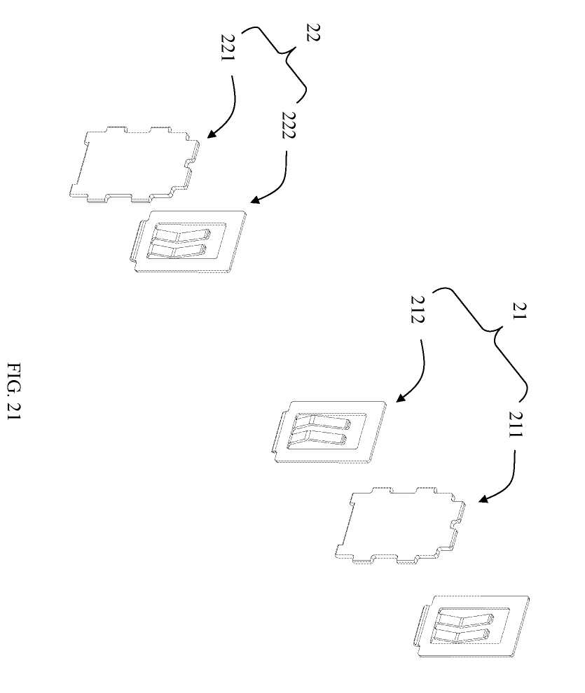

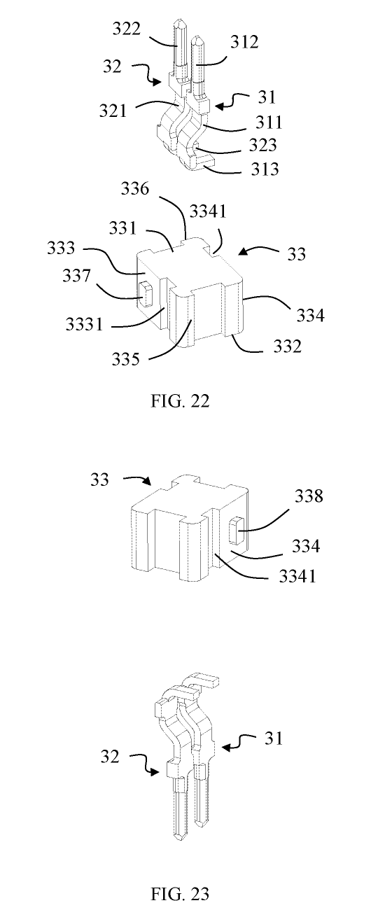

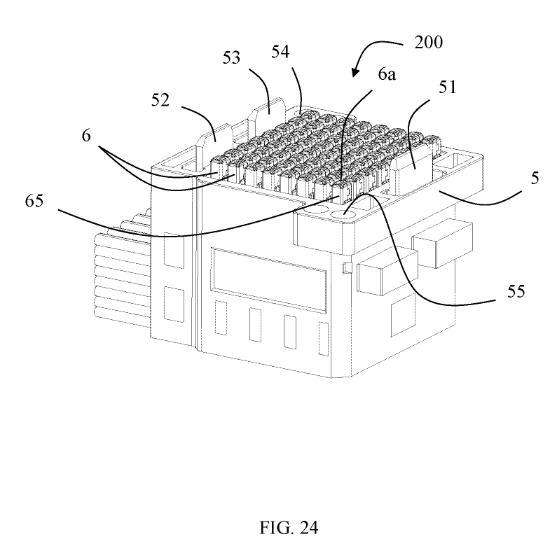

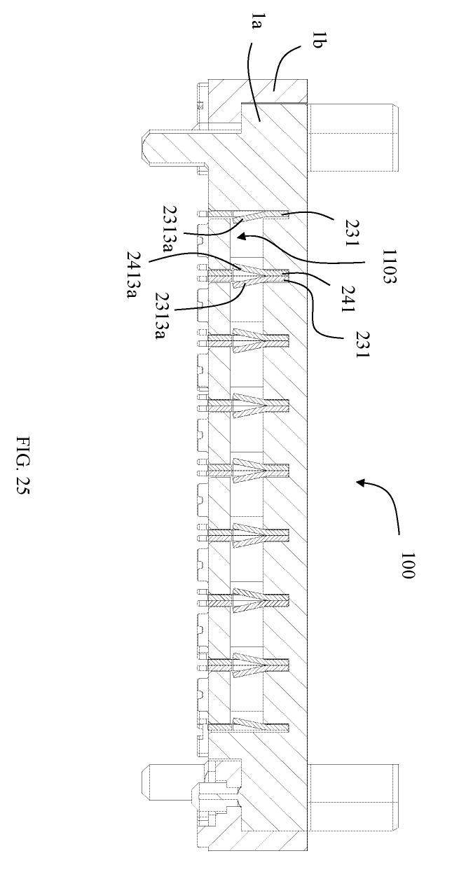

Referring to FIG. 1 to FIG. 25, the present disclosure discloses a connector assembly, including a circuit board 300, an electrical connector 100 mounted to the circuit board 300, and a mating connector configured to mate with the electrical connector 100. In the illustrated embodiment of the present disclosure, the electrical connector 100 is a board-end backplane connector. The mating connector is a cable connector 200, for example a cable-end backplane connector. Of course, it is understandable to those skilled in the art that in other embodiments of the present disclosure, the types of the electrical connector 100 and the mating connector may be flexibly adjusted as needed. The mating connector mates with the electrical connector 100 along a mating direction to achieve data transmission.

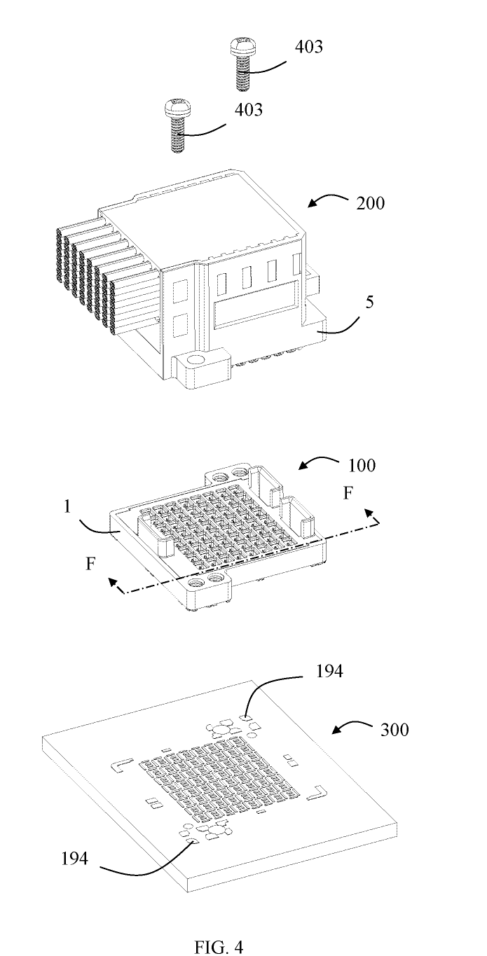

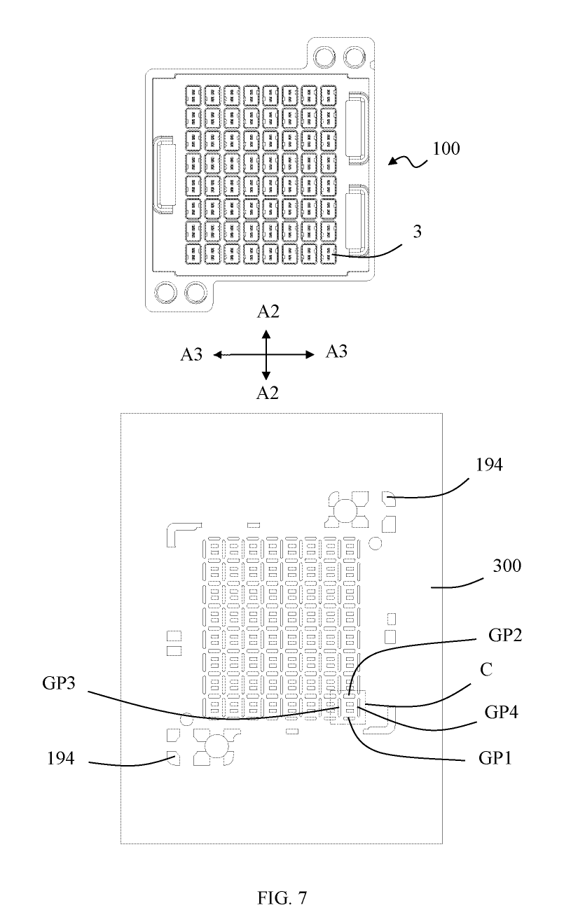

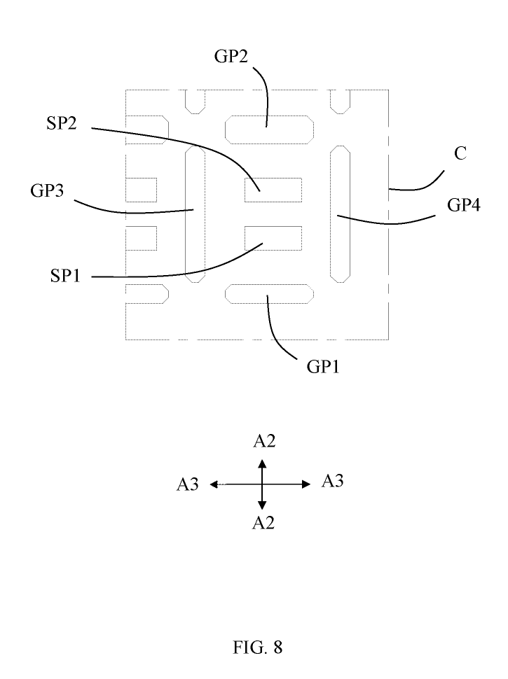

Referring to FIG. 4, FIG. 7 and FIG. 8, the circuit board 300 includes a plurality of conductive pads located on its surface (for example, an upper surface). The plurality of conductive pads are divided into several groups and are arranged in a matrix in a second direction A2-A2 (for example, a left-right direction) and a third direction A3-A3 (for example, a front-rear direction). Each group of conductive pads includes a first ground conductive pad GP1, a second ground conductive pad GP2, a third ground conductive pad GP3, a fourth ground conductive pad GP4, a first signal conductive pad SP1, and a second signal conductive pad SP2. In the illustrated embodiment of the present disclosure, the first ground conductive pad GP1, the second ground conductive pad GP2, the third ground conductive pad GP3 and the fourth ground conductive pad GP4 are generally enclosed to form a frame. Any two adjacent ground conductive pads of the first ground conductive pad GP1, the second ground conductive pad GP2, the third ground conductive pad GP3 and the fourth ground conductive pad GP4 are all arranged separately. That is, any two adjacent ground conductive pads of the first ground conductive pad GP1, the second ground conductive pad GP2, the third ground conductive pad GP3 and the fourth ground conductive pad GP4 are disconnected. The first signal conductive pad SP1 and the second signal conductive pad SP2 are located in the frame and are surrounded by the first ground conductive pad GP1, the second ground conductive pad GP2, the third ground conductive pad GP3 and the fourth ground conductive pad GP4 in order to improve the shielding effect and improve the quality of signal transmission. In one embodiment of the present disclosure, the first signal conductive pad SP1 and the second signal conductive pad SP2 form a differential pair to increase the rate of signal transmission. In the illustrated embodiment of the present disclosure, the two adjacent groups of conductive pads share one ground conductive pad. As for any group of first signal conductive pad SP1 and second signal conductive pad SP2, one first ground conductive pad GP1, one second ground conductive pad GP2, one third ground conductive pad GP3 and one fourth ground conductive pad GP4 are provided around them to ensure a good shielding effect.

Referring to FIG. 1 to FIG. 4, in the illustrated embodiment of the present disclosure, the connector assembly includes a plurality of fasteners that secure the electrical connector 100 to the circuit board 300. The fasteners include a first screw 401 and a second screw 402. The first screw 401 passes through the circuit board 300 and is fixed in the electrical connector 100. The second screw 402 passes through the circuit board 300 and is fixed in the electrical connector 100.

Referring to FIG. 4 to FIG. 24, in the illustrated embodiment of the present disclosure, the electrical connector 100 includes a mounting frame 1 and a plurality of shielding modules 30 mounted to the mounting frame 1. Each shielding module 30 includes a shielding assembly 2, and a plurality of terminal modules 3 mounted to the shielding assembly 2.

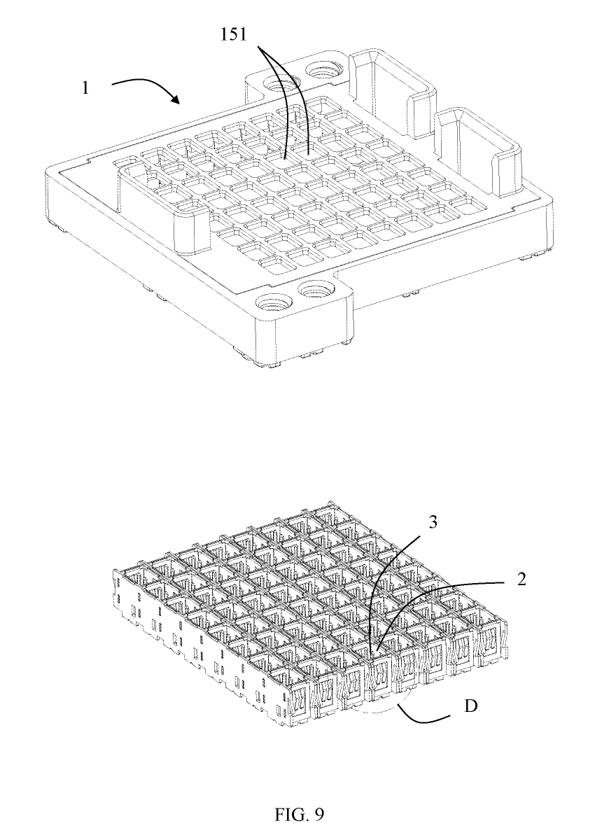

Referring to FIG. 9 and FIG. 11 to FIG. 14, in the embodiment of the present disclosure, the mounting frame 1 includes an inner frame 1a and an outer frame 1b. The inner frame 1a and the outer frame 1b are provided separately, and the inner frame 1a is disposed in the outer frame 1b. In one embodiment of the present disclosure, the inner frame 1a is an insulating inner frame, i.e., it is made of an insulating material. The outer frame 1b is a conductive outer frame. Specifically, in one embodiment of the present disclosure, the outer frame 1b is a metal outer frame, that is, the outer frame 1b is made of a metal material to improve shielding performance. Of course, in other embodiments, the inner frame 1a may also be a metal inner frame, or both the inner frame 1a and the outer frame 1b are metal frames. In one embodiment of the present disclosure, the inner frame 1a is fixed in the outer frame 1b in an interference fit manner.

In the embodiment of the present disclosure, the inner frame 1a includes a base plate portion 15, a first wall portion 11 connected to the base plate portion 15 and located on a first side of the base plate portion 15, a second wall portion 12 connected to the base plate portion 15 and located on a second side of the base plate portion 15, a third wall portion 13 connected to the base plate portion 15 and located on a third side of the base plate portion 15, and a fourth wall portion 14 connected to the base plate portion 15 and is located on a fourth side of the base plate portion 15. In the embodiment of the present disclosure, the first wall portion 11, the second wall portion 12, the third wall portion 13 and the fourth wall portion 14 are located around the base plate portion 15. The first wall portion 11 is disposed opposite to the second wall portion 12. The third wall portion 13 is disposed opposite to the fourth wall portion 14. The first wall portion 11, the second wall portion 12, the third wall portion 13 and the fourth wall portion 14 are surrounded by a rectangle to form a mounting space 10. The base plate portion 15 is located above the mounting space 10. In the embodiment of the present disclosure, the first wall portion 11, the second wall portion 12, the third wall portion 13 and the fourth wall portion 14 are provided with a mating surface 101 (for example, an upper surface), and a mounting surface 102 (for example, a lower surface) disposed opposite to the mating surface 101.

In the embodiment of the present disclosure, the base plate portion 15 defines a plurality of module receiving holes 151 extending through the base plate portion 15 in a first direction A1-A1 (for example, a top-bottom direction). Each module receiving hole 151 is generally rectangular. The plurality of module receiving holes 151 are arranged in a grid pattern along the second direction A2-A2 and the third direction A3-A3. In the illustrated embodiment of the present disclosure, the module receiving holes 151 are arranged in a matrix in the second direction A2-A2 and the third direction A3-A3. Each module receiving hole 151 is in communication with the mounting space 10. It is understandable to those skilled in the art that the technical term “matrix” used in the present disclosure should be understood in a broad sense, that is, it should include arrangements not in rows and columns due to process or slight deformation, etc. By providing the module receiving holes 151 on the mounting frame 1, the present disclosure is beneficial to improve the position accuracy of the module receiving holes 151, thereby improving the mating accuracy when it is mated with the cable connector 200. In the illustrated embodiment of the present disclosure, each module receiving hole 151 is a circumferentially enclosed hole to ensure the structural strength of the mounting frame 1 as much as possible.

In the embodiment of the present disclosure, the third wall portion 13 is further provided with a plurality of first mounting posts 131 protruding downwardly along the first direction A1-A1, and a first positioning protrusion 132 protruding upwardly along the first direction A1-A1. The first mounting protrusion post 131 is opposite to a protruding direction of the first positioning protrusion 132. Specifically, in the embodiment of the present disclosure, the first positioning protrusion 132 is generally U-shaped, and includes a first guide groove 1321 extending through the third wall portion 13 along the first direction A1-A1.

The fourth wall portion 14 is provided with a plurality of second mounting posts 141 protruding downwardly along the first direction A1-A1, and a second positioning protrusion 142 and a third positioning protrusion 143 that protrude upwardly along the first direction A1-A1. The second mounting post 141 is opposite to protruding directions of the second positioning protrusion 142 and the third positioning protrusion 143. In the embodiment of the present disclosure, the second positioning protrusion 142 is generally U-shaped, and includes a second guide groove 1421 extending through the fourth wall portion 14 along the first direction A1-A1. Similarly, the third positioning protrusion 143 is also generally U-shaped, including a third guide groove 1431 extending through the fourth wall portion 14 along the first direction A1-A1. It is understandable to those of ordinary skill in the art that by providing the first positioning protrusion 132 on the third wall portion 13, and the second positioning protrusion 142 and the third positioning protrusion 143 on the fourth wall portion 14, it can play a fool-proof role and ensure the correctness when cooperating with the cable connector 200. The first positioning protrusion 132, the second positioning protrusion 142 and the third positioning protrusion 143 all protrude upwardly beyond the mating surface 101. The first mounting posts 131 and the second mounting posts 141 protrude downwardly beyond the mounting surface 102. In the embodiment of the present disclosure, the first mounting posts 131 and the second mounting posts 141 are configured to cooperate with the outer frame 1b.

In the embodiment of the present disclosure, the inner side of the first wall portion 11 further defines a plurality of first mounting grooves 1101 that extend downwardly through the mounting surface 102 along the first direction A1-A1, a plurality of third mounting grooves 1102 that extend downwardly through the mounting surface 102 along the first direction A1-A1, and a first locking groove 1103 located between the first mounting grooves 1101 and the third mounting grooves 1102. The first locking groove 1103 is in communication with the adjacent first mounting grooves 1101 and the adjacent third mounting grooves 1102 along the third direction A3-A3. The first mounting grooves 1101 and the third mounting grooves 1102 are alternately arranged along the second direction A2-A2. The first mounting grooves 1101 and the third mounting grooves 1102 are exposed to the mounting space 10 and in communication with the mounting space 10. Each first mounting groove 1101 does not extend through the mating surface 101 upwardly along the first direction A1-A1 in order to ensure the structural strength of the first wall portion 11 as much as possible.

Similarly, the inner side of the second wall portion 12 further defines a plurality of second mounting grooves 1201 that extend downwardly through the mounting surface 102 along the first direction A1-A1, a plurality of fourth mounting grooves 1202 that extend downwardly through the mounting surface 102 along the first direction A1-A1, and a second locking groove (not shown) located between the second mounting grooves 1201 and the fourth mounting grooves 1202. The second mounting grooves 1201 and the fourth mounting grooves 1202 are alternately arranged along the second direction A2-A2. The second mounting grooves 1201 and the fourth mounting grooves 1202 are exposed to the mounting space 10 and in communication with the mounting space 10. Each second mounting groove 1201 does not extend through the mating surface 101 upwardly along the first direction A1-A1 to ensure the structural strength of the second wall portion 12 as much as possible.

In the embodiment of the present disclosure, the first mounting grooves 1101 and the third mounting grooves 1102 do not extend through the first wall portion 11 laterally outward. The second mounting grooves 1201 and the fourth mounting grooves 1202 do not extend through the second wall portion 12 laterally outward. With this arrangement, the present disclosure is able to reduce openings as much as possible, improve the shielding effect, and improve the quality of signal transmission. In the embodiment of the present disclosure, the first mounting groove 1101 and the second mounting groove 1201 aligned with each other are arranged to hold a corresponding portion of a shielding shell assembly 2, and the third mounting groove 1102 and the fourth mounting groove 1202 aligned with each other are configured to jointly hold another corresponding portion of the shielding shell assembly 2 (described in detail later).

In the embodiment of the present disclosure, the outer frame 1b is generally frame-shaped, and includes a first outer frame wall 16, a second outer frame wall 17 disposed opposite to the first outer frame wall 16, a third outer frame wall 18 connecting one end of the first outer frame wall 16 and one end of the second outer frame wall 17, a fourth outer frame wall 19 connecting another end of the first outer frame wall 16 and another end of the second outer frame wall 17, and an accommodating cavity 190 surrounded by the first outer frame wall 16, the second outer frame wall 17, the third outer frame wall 18, and the fourth outer frame wall 19. The accommodating cavity 190 is configured to at least partially accommodate the inner frame 1a. The first outer frame wall 16 corresponds to the first wall portion 11. The second outer frame wall 17 corresponds to the second wall portion 12. The third outer frame wall 18 corresponds to the third wall portion 13. The fourth outer frame wall 19 corresponds to the fourth wall portion 14.

In the embodiment of the present disclosure, the third outer frame wall 18 is provided with a first limiting protrusion 181 protruding into the accommodating cavity 190. The first limiting protrusion 181 defines a first mounting through-hole 182. The first limiting protrusion 181 is configured to abut against the inner frame 1a along the first direction A1-A1 to support the inner frame 1a and to limit the inner frame 1a. At least part of the first mounting post 131 is inserted and passes through the first mounting through-hole 182 for positioning with the circuit board 300.

Similarly, in the embodiment of the present disclosure, the fourth outer frame wall 19 is provided with a second limiting protrusion 191 protruding into the accommodating cavity 190. The second limiting protrusion 191 defines a second mounting through-hole 192. The second limiting protrusion 191 is configured to abut against the inner frame 1a in the first direction A1-A1 to support the inner frame 1a and to limit the inner frame 1a. At least part of the second mounting post 141 is inserted and passes through the second mounting through-hole 192 for positioning with the circuit board 300.

In one embodiment of the present disclosure, when the inner frame 1a is made of an insulating material, at least a portion of the first mounting post 131 is inserted into the first mounting through-hole 182, and at least part of the second mounting post 141 is inserted into the second mounting through-hole 192. At this time, by means of hot melting and other processes, the first mounting post 131 and the second mounting post 141 can be melted, thereby being better fixed with the outer frame 1b.

In addition, in the illustration embodiment of the present disclosure, the first outer frame wall 16, the second outer frame wall 17, the third outer frame wall 18, and the fourth outer frame wall 19 are all provided with a plurality mounting protrusions 193 that protrude downwardly beyond the mounting surface 102 along the first direction A1-A1. The mounting protrusions 193 are configured to support the circuit board 300 so that a gap is provided between the mounting surface 102 and the upper surface of the circuit board 300 to facilitate heat dissipation. In the embodiment of the present disclosure, a plurality of thin films 194 are provided on the mounting protrusions 193. Each film 194 is sandwiched between the mounting protrusion 193 and the circuit board 300 to reduce the risk of damage to the circuit board 300.

Besides, the outer frame 1b also includes a first mounting through hole 195 located in one corner thereof, and a second mounting through hole 196 located in another corner thereof. In the illustrated embodiment of the present disclosure, the corner where the first mounting through hole 195 is located and the corner where the second mounting through hole 196 is located is approximately two corners diagonally on the outer frame 1b. In the illustrated embodiment of the present disclosure, the first mounting through hole 195 and the second mounting through hole 196 are threaded holes. When the outer frame 1b is made of a metal material, the threaded hole is provided to ensure the reliability of tightening, improve the convenience of installation, and help reduce the height.

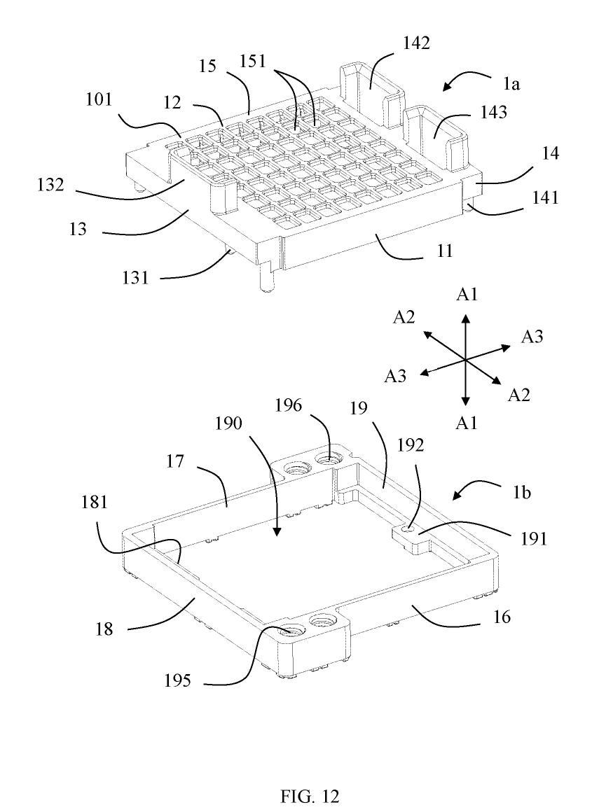

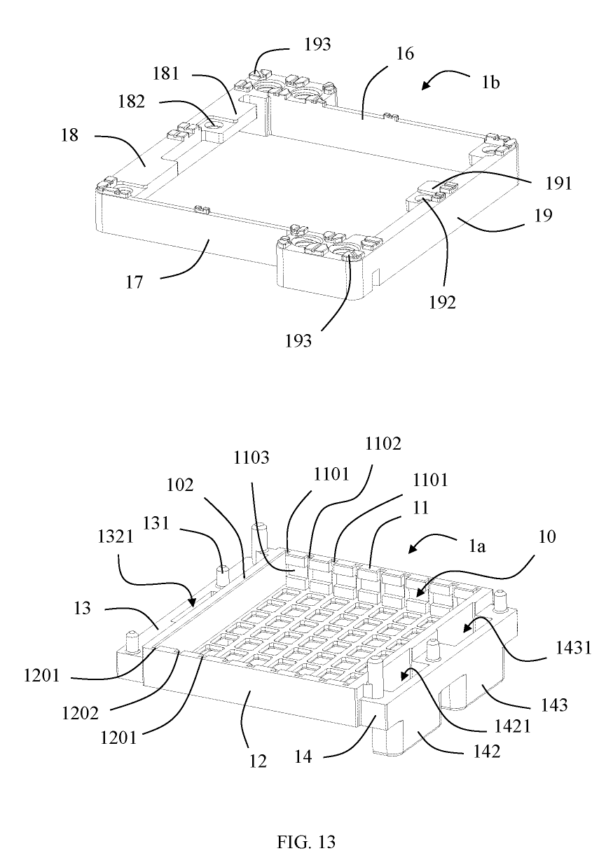

In another embodiment of the present disclosure, the mounting frame 1 is of a one-piece configuration, that is, the inner frame 1a and the outer frame 1b in FIG. 12 and FIG. 13 are combined as a whole. The mounting frame 1 is a conductive frame. Specifically, the mounting frame 1 is a metal outer frame, i.e., the mounting frame 1 is made of a metal material to improve shielding performance. The mounting frame 1 can be manufactured by a metal powder sintering process.

Referring to FIG. 9 to FIG. 21, in the illustration embodiment of the present disclosure, the shielding shell assembly 2 includes a plurality first shielding plate assemblies 21 and a plurality of second shielding plate assemblies 22 which are spaced apart along the second direction A2-A2, and a third shielding plate assembly 23 and a fourth shielding plate assembly 24 which are spaced apart along the third direction A3-A3. The first shielding plate assemblies 21 and the second shielding plate assemblies 22 are fixed with the third shielding plate assembly 23 and the fourth shielding plate assembly 24 to form a plurality of shielding units 20. Each shielding unit 20 defines a shielding cavity 25. The terminal modules 3 are installed in the shielding cavities 25 of corresponding shielding units 20.

Specifically, in the illustrated embodiment of the present disclosure, the first shielding plate assembly 21 includes a first metal plate 211 and a first metal shrapnel 212 fixed to the first metal plate 211. In the illustrated embodiment of the present disclosure, the first metal shrapnel 212 is soldered, welded or riveted to at least an inner side of the first metal plate 211.

The first metal plate 211 includes a first main body portion 2111, and a first soldering portion 2112 integrally extending downwardly from the first main body portion 2111 in the first direction A1-A1. The first main body portion 2111 includes a plurality of first protruding portions 2111a protruding from one side of the first main body portion 2111 along the third direction A3-A3, a plurality of second protruding portions 2111b protruding from another side of the first main body portion 2111 along the third direction A3-A3, and a first notch 2111c recessed downwardly from a top of the first main body portion 2111 along the first direction A1-A1.

The first metal shrapnel 212 includes a first base portion 2121 and a first protrusion 2122 extending upwardly beyond the first base portion 2121 along the first direction A1-A1. The first base portion 2121 includes a first opening 21211 extending through the first base portion 2121 along a thickness direction of the first base portion 2121, and a first abutment elastic arm 21212 protruding into the first opening 21211 along the first direction A1-A1. A root of the first abutment elastic arm 21212 is connected to the first base portion 2121. Another end of the first abutment elastic arm 21212 disposed opposite to the root is a movable end. In other words, the first abutment elastic arm 21212 extends from top to bottom along the first direction A1-A1. In this way, on the one hand, the first abutment elastic arm 21212 can guide the cable connector 200 when it is inserted into the electrical connector 100. On the other hand, the insertion force of the cable connector 200 can also be reduced. The first abutment elastic arm 21212, when it is in a free state, includes a first abutting portion 21213 protruding from the first base portion 2121 along the thickness direction of the first base portion 2121.

In the illustrated embodiment of the present disclosure, corresponding to a first opening 21211, two first abutment elastic arms 21212 are provided, and the movable ends of the two first abutment elastic arms 21212 are separated from each other. Of course, in other embodiments of the present disclosure, may be one first abutment elastic arm 21212 is provided and disposed corresponding to one first opening 21211. Alternatively, corresponding to a first opening 21211, two first abutment elastic arms 21212 are provided, and the first base portion 2121 includes a first connecting portion connecting the movable ends of the two first abutting arms 21212 together.

In one embodiment of the present disclosure, in a free state, the movable end of the first abutment elastic arm 21212 abuts against the first inner side surface of the first metal plate 211, that is, the first abutment elastic arm 21212 is a simple support beam. It is understandable to those skilled in the art that by designing the first abutment elastic arm 21212 as a simple support beam, it is beneficial to increasing the plugging and unplugging force of the cable connector 200, improving mating reliability, and effectively reducing resonance problems. Of course, in other embodiments of the present disclosure, the first abutment elastic arm 21212 which is a simple support beam may have two ends as fixed ends.

In another embodiment of the present disclosure, in the free state, the movable end of the first abutment elastic arm 21212 does not abut against the first inner side surface of the first metal plate 2111, that is, the first abutment elastic arm 21212 is a cantilever beam. It is understandable to those skilled in the art that by designing the first abutment elastic arm 21212 as a cantilever beam, it is beneficial to reducing the plugging and unplugging force of the cable connector 200, thereby facilitating the insertion of the cable connector 200. When the cable connector 200 is inserted, the first abutting portion 21213 of the first abutment elastic arm 21212 is pressed against by the cable connector 200 to be elastically deformed. At this time, the movable end of the first abutment elastic arm 21212 abuts against the first inner side surface of the first metal plate 211 to form a simple support beam, so that the resonance problem can be reduced.

In the illustrated embodiment of the present disclosure, a width of the first protrusion 2122 in the third direction A3-A3 is smaller than a width of the first base portion 2121 in the third direction A3-A3. The first protrusion 2122 is deflected to form a guide surface, and the first protrusion 2122 is at least partially accommodated in the first notch 2111c.

Specifically, in the illustration embodiment of the present disclosure, the second shielding plate assembly 22 includes a second metal plate 221 and a second metal shrapnel 222 fixed to the second metal plate 221. In the illustrated embodiment of the present disclosure, the second metal shrapnel 222 is soldered, welded or riveted to at least an inner side of the second metal plate 221.

The second metal plate 221 includes a second main body portion 2211, and a second soldering portion 2212 integrally extending downwardly from the second main body portion 2211 in the first direction A1-A1. The second main body portion 2211 includes a plurality of third protruding portions 2211a protruding from one side of the second main body portion 2211 along the third direction A3-A3, a plurality of fourth protruding portions 2211b protruding from another side of the second main body portion 2211 along the third direction A3-A3, and a second notch 2211c recessed downwardly from a top of the second main body portion 2211 along the first direction A1-A1.

The second metal shrapnel 222 includes a second base portion 2221 and a second protrusion 22222 that protrudes upwardly along the first direction A1-A1. The second base portion 2221 includes a second opening 22211 extending through the second base portion 2221 along a thickness direction of the second base portion 2221, and a second abutment elastic arm 22212 protruding into the second opening 22211 in the first direction A1-A1. A root of the second abutment elastic arm 22212 is connected to the second base portion 2221. Another end on the second abutment elastic arm 22212 disposed opposite to the root is a movable end. In other words, the second abutment elastic arm 22212 extends from top to bottom in the first direction A1-A1. In this way, on the one hand, the second abutment elastic arm 22212 can guide the cable connector 200 when it is inserted into the electrical connector 100. On the other hand, the insertion force of the cable connector 200 can also be reduced. The second abutment elastic arm 22212, when it is in a free state, includes a second abutment portion 22213 protruding from the second base portion 2221 in the thickness direction of the second base portion 2221.

It is understandable to those skilled in the art that in the illustrated embodiment of the present disclosure, corresponding to a second opening 22211, two second abutment elastic arms 22212 are provided, and the movable ends of the two second abutment elastic arms 22212 are separated from each other. In another embodiment of the present disclosure, may be one second abutment elastic arm 22212 is provided and disposed corresponding to one second opening 22211.Alternatively, corresponding to a second opening 22211, two second abutment elastic arms 22212 are provided, and the second base portion 2221 is provided with a second connecting portion connecting the movable ends of the two second abutment elastic arms 22212 together.

In one embodiment of the present disclosure, in the free state, the movable end of the second abutment elastic arm 22212 abuts against the second inner side surface of the second metal plate 2211, that is, the second abutment elastic arm 22212 is a simple support beam. It is understandable to those skilled in the art that by designing the second abutment elastic arm 22212 as a simple support beam, it is beneficial to increasing the plugging and unplugging force of the cable connector 200, improving mating reliability, and effectively reducing resonance problems. Of course, in other embodiments of the present disclosure, the second elastic abutment elastic arm 22212 which is a simple support beam may have two ends as fixed ends.

In one embodiment of the present disclosure, in the free state, the movable end of the second abutment elastic arm 22212 does not abut against the second inner side surface of the second metal plate 221, that is, the second abutment elastic arm 22212 is a cantilever beam. It is understandable to those skilled in the art, by designing the second abutment elastic arm 22212 as a cantilever beam, it is beneficial to reducing the plugging and unplugging force of the cable connector 200, thereby facilitating the insertion of the cable connector 200. When the cable connector 200 is inserted, the second abutment portion 22213 of the second abutment elastic arm 22212 is pressed against by the cable connector 200 and elastically deformed. At this time, the movable end of the second abutment elastic arm 22212 abuts against the second inner side surface 2211a of the second metal plate 221 to form a simple support beam, so that the resonance problem can be reduced.

In the illustrated embodiment of the present disclosure, a width of the second protrusion 2222 along the third direction A3-A3 is smaller than a width of the second base portion 2221 along the third direction A3-A3. The second protrusion 2222 is deflected to form a guide surface, and the second protrusion 2222 is at least partially accommodated in the second notch 22131.

Specifically, in the illustration embodiment of the present disclosure, the third shielding plate assembly 23 includes a third metal plate 231 and a third metal shrapnel 232 fixed to the third metal plate 231. In the illustrated embodiment of the present disclosure, the third metal shrapnel 232 is soldered, welded or riveted to at least an inner side of the third metal plate 231.

The third metal plate 231 includes a third main body portion 2311, a plurality of third soldering portions 2312 extending integrally downward from the third main body portion 2311 along the first direction A1-A1, a first insertion portion 2313 connected to one end of the third main body portion 2311, and a second insertion portion 2314 connected to another end of the third main body portion 2311. The first insertion portion 2313 is provided with a first locking tab 2313a protruding toward the fourth shielding plate assembly 24. The second insertion portion 2314 is provided with a second locking tab 2314a protruding toward the fourth shielding plate assembly 24. The first insertion portion 2313 is configured to be inserted into the first mounting grooves 1101. The second insertion portion 2314 is configured to be inserted into the second mounting grooves 1201. The first locking tab 2313a and the second locking tab 2314a both protrude into the first locking groove 1103 and are locked with the mounting frame 1 to prevent the third metal plate 231 from being separated from the mounting frame 1.

The third main body portion 2311 includes a plurality of first receiving grooves 2311a spaced apart along the first direction A1-A1, a plurality of third receiving grooves 2311b spaced apart along the first direction A1-A1, and a first positioning groove 2311d located between the first receiving grooves 2311a and the third receiving grooves 2311b along the second direction A2-A2. Furthermore, the third main body portion 2311 defines a third notch 2311c recessed downwardly from its top end along the first direction A1-A1.

The third metal shrapnel 232 includes a third base portion 2321 and a third protrusion 2322 that protrudes upwardly along the first direction A1-A1. The third base portion 2321 includes a third opening 23211 that extends through the third base portion 2321 in a thickness direction of the third base portion 2321, and a third abutment elastic arm 23212 that protrudes into the third opening 23211 in the first direction A1-A1. A root of the third abutment elastic arm 23212 extends integrally with the third base portion 2321. Another end on the third abutment elastic arm 23212 disposed opposite to the root is a movable end. In other words, the third abutment elastic arm 23212 extends from top to bottom along the first direction A1-A1. In this way, the third abutment elastic arm 23212 can, on the one hand, guide the cable connector 200 when it is inserted into the electrical connector 100. On the other hand, the insertion force of the cable connector 200 can also be reduced. The third abutment elastic arm 23212, when it is in a free state, includes a third abutment portion 23213 protruding from the third base portion 2321.

It is understandable to those skilled in the art that in the illustrated embodiment of the present disclosure, corresponding to a third opening 23211, one the third abutment elastic arm 23212 is provided. In other embodiments of the present disclosure, corresponding to a third opening 23211, two third abutment elastic arms 23212 are provided, and the movable ends of the two third abutment elastic arms 23212 are separated from each other. Alternatively, corresponding to a third opening 23211, two third abutment elastic arms 23212 are provided, and the third base portion 2321 is provided with a third connecting portion connecting the movable ends of the two third abutment elastic arms 23212 together.

In one illustrated embodiment of the present disclosure, in the free state, the movable end of the third abutment elastic arm 23212 abuts against the third inner side surface of the third metal plate 231, that is, the third abutment elastic arm 23212 is a simple support beam. It is understandable to those skilled in the art that by designing the third abutment elastic arm 23212 as a simple support beam, it is beneficial to increasing the plugging and unplugging force of the cable connector 200, improving docking reliability, and effectively reducing resonance problems. Of course, in other embodiments of the present disclosure, the third abutment elastic arm 23212 which is a simple support beam may have two ends as fixed ends.

In another embodiment of the present disclosure, in the free state, the movable end of the third abutment elastic arm 23212 does not abut against the third inner side surface of the third metal plate 231, that is, the third abutment elastic arm 23212 is a cantilever beam. It is understandable to those skilled in the art that by designing the third abutment elastic arm 23212 in the form of a cantilever beam, it will help reduce the plugging and pulling force of the cable connector 200 and facilitate insertion of the cable connector 200. When the cable connector 200 is inserted, the third abutment portion 23213 of the third abutment elastic arm 23212 is pressed against by the cable connector 200 and elastically deformed. At this time, the movable end of the third abutment elastic arm 23212 abuts against the third inner side surface of the third metal plate 231 to form a simple support beam, so that the resonance problem can be reduced. In addition, the third base portion 2321 further defines a first opening hole 2321d corresponding to the first positioning groove 2311d.

In the illustrated embodiment of the present disclosure, a width of the third protrusion 2322 along the third direction A3-A3 is smaller than a width of the third base 2321 along the third direction A3-A3. The third protrusion 2322 is deflected to form a guide surface, and the third protrusion 2322 is at least partially accommodated in the third notch 23131.

In the illustration embodiment of the present disclosure, the fourth shielding plate assembly 24 includes a fourth metal plate 241 and a fourth metal shrapnel 242 fixed to the fourth metal plate 241. In the illustrated embodiment of the present disclosure, the fourth metal shrapnel 242 is soldered, welded or riveted to at least an inner side of the fourth metal plate 241.

The fourth metal plate 241 includes a fourth main body portion 2411, a plurality of fourth soldering portions 2412 extending integrally downward from the fourth main body portion 2411 along the first direction A1-A1, a third insertion portion 2413 connected to one end of the fourth main body portion 2411, and a fourth insertion portion 2414 connected to another end of the fourth main body portion 2411. The third insertion portion 2413 is provided with a third locking tab 2413a that protrudes toward the third shielding plate assembly 23. The fourth insertion portion 2414 is provided with a fourth locking tab 2414a that protrudes toward the third shielding plate assembly 23. The third insertion portion 2413 is configured to be inserted into the third mounting grooves 1102. The fourth insertion portion 2414 is configured to be inserted into the fourth mounting grooves 1202. The third locking protrusion 2413a and the fourth locking protrusion 2414a both protrude into the second locking groove, and are locked with the mounting frame 1 to prevent the fourth metal plate 241 from being separated from the mounting frame 1.

The fourth main body portion 2411 includes a plurality of second receiving grooves 2411a spaced apart along the first direction A1-A1, a plurality of fourth receiving grooves 2411b spaced apart along the first direction A1-A1, and a second positioning groove 2411d located between the second receiving grooves 2411a and the fourth receiving grooves 2411b along the second direction A2-A2. Furthermore, the fourth main body portion 2411 is further defined by a fourth notch 2411c recessed downwardly from its top end along the first direction A1-A1.

The fourth metal shrapnel 242 includes a fourth base portion 2421 and a fourth protrusion 2422 that protrudes upwardly along the first direction A1-A1. The fourth base portion 2421 includes a fourth opening 24211 that extends through the fourth base portion 2421 in a thickness direction of the fourth base portion 2421, and a fourth abutment elastic arm 24212 that protrudes into the fourth opening 24211 in the first direction A1-A1. A root of the fourth abutment elastic arm 24212 extends integrally with the fourth base portion 2421. Another end on the fourth abutment elastic arm 24212 disposed opposite to the root is a movable end. In other words, the fourth abutment elastic arm 24212 extends from top to bottom in the first direction A1-A1. In this way, on the one hand, the fourth abutment elastic arm 24212 can guide the cable connector 200 when it is inserted into the electrical connector 100. On the other hand, the insertion force of the cable connector 200 can also be reduced. The fourth abutment elastic arm 24212, when it is in a free state, includes a fourth abutment portion 24213 protruding from the fourth base portion 2421 in the thickness direction of the fourth base portion 2421.

It is understandable to those skilled in the art that in one embodiment of the disclosure, corresponding to a fourth opening 24211, one fourth abutment elastic arm 24212 is provided. In other embodiments of the present disclosure, corresponding to a fourth opening 24211, two fourth abutment elastic arms 24212 are provided, and the movable ends of the two fourth abutment elastic arms 24212 are separated from each other. Alternatively, corresponding to a fourth opening 24211, two fourth abutment elastic arms 24212 are provided, and the fourth base portion 2421 is provided with a fourth connecting portion connecting the movable ends of the two fourth abutment elastic arms 24212 together.

In one embodiment of the present disclosure, in the free state, the movable end of the fourth abutment elastic arm 24212 abuts against the fourth inner side surface of the fourth metal plate 241, that is, the fourth abutment elastic arm 24212 is a simple support beam. It is understandable to those skilled in the art that by designing the fourth abutment elastic arm 24212 in the form of a simple support beam, it will help increase the plugging and pulling force of the cable connector 200, improve docking reliability, and effectively reduce resonance problems. Of course, in other embodiments of the present disclosure, two ends of the fourth abutment elastic arm 24212 which is a simple support beam may be fixed ends.

In another embodiment of the present disclosure, in a free state, the movable end of the fourth abutment elastic arm 24212 does not abut against the fourth inner side surface of the fourth metal plate 241, that is, the fourth abutment elastic arm 24212 is a cantilever beam. It is understandable to those skilled in the art that by designing the fourth abutment elastic arm 24212 in the form of a cantilever beam, it will help reduce the plugging and pulling force of the cable connector 200 and facilitate insertion of the cable connector 200. When the cable connector 200 is inserted, the fourth abutment portion 24213 of the fourth abutment elastic arm 24212 is pressed against by the cable connector 200 and elastically deformed. At this time, the movable end of the fourth abutment elastic arm 24212 abuts against the fourth inner side surface of the fourth metal plate 241 to form a simple support beam, so that the resonance problem can be reduced. In addition, the fourth base portion 2421 further defines a second opening hole 2421d corresponding to the second positioning groove 2411d.

In the illustrated embodiment of the present disclosure, the plurality of terminal modules 3 are the same. Each terminal module 3 includes an insulating block 33, a first conductive terminal 31 secured to the insulating block 33, and a second conductive terminal 32 secured to the insulating block 33. In one embodiment of the present disclosure, the first conductive terminal 31 and the second conductive terminal 32 are insert-molded with the insulating block 33 to be combined into a whole. Of course, it is understandable to those skilled in the art that in other embodiments of the present disclosure, the first conductive terminal 31 and the second conductive terminal 32 may also be secured to the insulating block 33 by other means (for example, by assembly). In one embodiment of the present disclosure, the first conductive terminal 31 and the second conductive terminal 32 form a differential pair to increase the rate of signal transmission.

The insulating block 33 includes a top surface 331, a bottom surface 332, a first side wall 333, a second side wall 334 disposed opposite to the first side wall 333, a third side wall 335, and a fourth side wall 336 disposed opposite to the third side wall 335.

In the illustrated embodiment of the present disclosure, the first side wall 333 is provided with a first protruding rib 337 protruding outward, and the first protruding rib 337 is configured to be held in the first positioning groove 2311d and the first opening hole 2321d. The second side wall 334 is provided with a second protruding rib 338 protruding outward, and the second protruding rib 338 is configured to be held in the second positioning groove 2411d and the second opening hole 2421d.

In the illustrated embodiment of the present disclosure, the first side wall 333 defines a first through groove 3331 extending through the top surface 331 and the bottom surface 332 in the first direction A1-A1. The second side wall 334 defines a second through groove 3341 extending through the top surface 331 and the bottom surface 332 in the first direction A1-A1. By providing the first through groove 3331 and the second through groove 3341, when the electrical connector 100 goes through a reflow soldering furnace, heat can be transferred to the intermediate area of the electrical connector 100, thereby allowing the entire area to be heated evenly and improving the soldering or welding quality.

The first conductive terminal 31 includes a first fixing portion 311 secured in the insulating block 33, a first contact portion 312 extending from one end of the first fixing portion 311 and protruding upwardly beyond the insulating block 33, and a first tail portion 313 extending from another end of the first fixing portion 311 and protruding downwardly beyond the insulating block 33. In the illustrated embodiment of the present disclosure, the first contact portion 312 is in a needle shape and protrudes into the shielding cavity 25. The first tail portion 313 is substantially in a flat shape and is mounted on the first signal conductive pad SP1 of the circuit board 300 via a surface mounting technology.

Similarly, the second conductive terminal 32 includes a second fixing portion 321 secured in the insulating block 33, a second contact portion 322 extending from one end of the second fixing portion 321 and protruding upwardly beyond the insulating block 33, and a second tail portion 323 extending from another end of the second fixing portion 321 and protruding downwardly beyond the insulating block 33. In the illustrated embodiment of the present disclosure, the second contact portion 322 is in a needle shape and protrudes into the shielding cavity 25. The second tail portion 323 is generally in a flat shape and is mounted on the second signal conductive pad SP2 of the circuit board 300 via a surface mounting technology.

During assembly, the terminal module 3 is positioned in the shielding cavity 25 defined by the first shielding plate assembly 21, the second shielding plate assembly 22, the third shielding plate assembly 23, and the fourth shielding plate assembly 24. The first protruding portion 2111a of the first shielding plate assembly 21 is inserted into the first receiving groove 2311a. The second protruding portion 2111b of the first shielding plate assembly 21 is inserted into the second receiving groove 2411a. The third protruding portion 2211a of the second shielding plate assembly 22 is inserted into the third receiving groove 2311b. The fourth protruding portion 2211b of the second shielding plate assembly 22 is inserted into the fourth receiving groove 2411b. To improve structural reliability, the first protruding portion 2111a and the third protruding portion 2211a are fixed to the third metal plate 231 by soldering or welding. The second protruding portion 2111b and the fourth protruding portion 2211b are fixed to the fourth metal plate 241 by soldering or welding. The first abutment elastic arm 21212, the second abutment elastic arm 22212, the third abutment elastic arm 23212, and the fourth abutment elastic arm 24212 all protrude into the shielding cavity 25. Of course, it is understandable to those skilled in the art that at least one of the first abutment elastic arm 21212, the second abutment elastic arm 22212, the third abutment elastic arm 23212, and the fourth abutment elastic arm 24212 may also be disposed in the shielding cavity 25.

When the electrical connector 100 is assembled, the first soldering portion 2112, the second soldering portion 2212, the third soldering portion 2312, and the fourth soldering portion 2412 all protrude downwardly beyond the mounting surface 102 along the first direction A1-A1. The first soldering portion 2112, the second soldering portion 2212, the third soldering portion 2312, and the fourth soldering portion 2412 are fixed to the first ground conductive plate GP1, the second ground conductive plate GP2, the third ground conductive plate GP3, and the fourth ground conductive plate GP4, respectively, by soldering or welding.

The first tail portion 313 and the second tail portion 323 are at least partially located in a shielding space 26 enclosed by the first soldering portion 2112, the second soldering portion 2212, the third soldering portion 2312, and the fourth soldering portion 2412. That is, the first tail portion 313 and the second tail portion 323 are surrounded by the first soldering portion 2112, the second soldering portion 2212, the third soldering portion 2312, and the fourth soldering portion 2412 at their respective heights, thereby improving the shielding effect of the soldering/welding ends. Furthermore, the first soldering portion 2112 defines a first ventilation groove 2112a at its bottom. The second soldering portion 2212 defines a second ventilation groove 2212a at its bottom. The third soldering portion 2312 defines a third ventilation groove 2312a at its bottom. The fourth welding portion 2412 defines a fourth ventilation groove 2412a at its bottom. As a result, when the product passes through the reflow soldering furnace, heat can be transferred to the middle area of the electrical connector 100, so that the entire area is heated evenly, thereby improving the welding/soldering quality.

The mating connector includes an accommodating housing 5, a plurality of cable modules 6 located at least partially in the accommodating housing 5, and an over-molding housing 7 formed on the cable modules 6 and fixed to the accommodating housing 5. In one embodiment of the present disclosure, the accommodating housing 5 is a metal housing made of a metal material. For example, the accommodating housing 5 is manufactured in the form of powder metallurgy to improve structural strength and shielding effect. Referring to FIG. 40, in one embodiment of the mating connector of the present disclosure, the accommodating housing 5 is provided with a first positioning plate 51 which is located on one side, and a second positioning plate 52 and a third positioning plate 53 which are located on another side. The first positioning plate 51 is configured to be inserted into the first guide groove 1321. The second positioning plate 52 is configured to be inserted into the second guide groove 1421. The third positioning plate 53 is configured to be inserted into the third guide groove 1431.

Besides, the accommodating housing 5 defines a first assembly hole 54 and a second assembly hole 55. The connector assembly includes a plurality of fasteners that secure the mating connector and the electrical connector 100 together. The fasteners include a third screw 403 and a fourth screw 404. The third screw 403 passes through the first assembly hole 54 and is fixed in the electrical connector 100. The fourth screw 404 passes through the second assembly hole 55 and is fixed in the electrical connector 100.

In the illustrated embodiment of the mating connector, each cable module 6 includes a plurality of cable blocks 6a disposed at intervals, and a plurality of metal shield enclosures 65 sleeved on the cable blocks 6a. When the cable connector 200 is mating with the electrical connector 100, the metal shield enclosures 65 of the cable connector 200 pass through the module receiving holes 151 to be at least partially accommodated in the shielding cavities 25 of the electrical connector 100. At least one of the first abutment elastic arm 21212, the second abutment elastic arm 22212, the third abutment elastic arm 23212 and the fourth abutment elastic arm 24212 elastically abuts against the metal shield enclosure 65, thereby improving the shielding effect. In the illustrated embodiment of the present disclosure, the first abutment elastic arm 21212, the second abutment elastic arm 22212, the third abutment elastic arm 23212 and the fourth abutment elastic arm 24212 all elastically abut against the metal shield enclosure 65.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a mounting frame defining a mounting space;
a shielding shell assembly at least partially received in the mounting space; the shielding shell assembly comprising a first shielding plate assembly, a second shielding plate assembly, a third shielding plate assembly, and a fourth shielding plate assembly; the first shielding plate assembly and the second shielding plate assembly being arranged opposite to each other; the third shielding plate assembly and the fourth shielding plate assembly being arranged opposite to each other; two ends of the first shielding plate assembly being coupled to the third shielding plate assembly and the fourth shielding plate assembly, respectively; two ends of the second shielding plate assembly are coupled to the third shielding plate assembly and the fourth shielding plate assembly, respectively; the first shielding plate assembly, the second shielding plate assembly, the third shielding plate assembly and the fourth shielding plate assembly jointly forming a shielding unit, and the shielding unit defining a shielding cavity; and
a terminal module at least partially received in the shielding cavity, the terminal module comprising an insulating block, a first conductive terminal disposed on the insulating block, and a second conductive terminal disposed on the insulating block.

2. The electrical connector according to claim 1, wherein the two ends of the first shielding plate assembly are fixed to the third shielding plate assembly and the fourth shielding plate assembly, respectively, by soldering or welding; the two ends of the second shielding plate assembly are fixed to the third shielding plate assembly and the fourth shielding plate assembly, respectively, by soldering or welding.

3. The electrical connector according to claim 1, wherein the first shielding plate assembly comprises a first metal plate, the first metal plate comprises a first main body portion, and the first main body portion comprises a first protruding portion and a second protruding portion;
the second shielding plate assembly comprises a second metal plate, the second metal plate comprises a second main body portion, and the second main body portion comprises a third protruding portion and a fourth protruding portion;
the third shielding plate assembly comprises a third metal plate, and the third metal plate defines a first receiving groove and a third receiving groove;
the fourth shielding plate assembly comprises a fourth metal plate, and the fourth metal plate comprises a second receiving groove and a fourth receiving groove;
the first protruding portion is inserted in the first receiving groove, the second protruding portion is inserted in the second receiving groove, the third protruding portion is inserted in the third receiving groove, and the fourth protruding portion is inserted in the fourth receiving groove.

4. The electrical connector according to claim 3, wherein the first protruding portion and the third protruding portion are fixed to the first main body portion by soldering or welding; and the second protruding portion and the fourth protruding portion are fixed to the second main body portion by soldering or welding.

5. The electrical connector according to claim 3, wherein the first shielding plate assembly comprises a first metal shrapnel fixed to the first metal plate, and the first metal shrapnel is provided with a first abutment elastic arm protruding into the shielding cavity.

6. The electrical connector according to claim 3, wherein the second shielding plate assembly comprises a second metal shrapnel fixed to the second metal plate, and the second metal shrapnel is provided with a second abutment elastic arm protruding into the shielding cavity.

7. The electrical connector according to claim 3, wherein the third shielding plate assembly comprises a third metal shrapnel fixed to the third metal plate, and the third metal shrapnel is provided with a third abutment elastic arm protruding into the shielding cavity.

8. The electrical connector according to claim 3, wherein the fourth shielding plate assembly comprises a fourth metal shrapnel fixed to the fourth metal plate, and the fourth metal shrapnel is provided with a fourth abutment elastic arm protruding into the shielding cavity.

9. The electrical connector according to claim 3, wherein the first metal plate comprises a first soldering portion integrally extending from the first main body portion; the second metal plate comprises a second soldering portion integrally extending from the second main body portion; the third metal plate comprises a third main body portion and a third soldering portion integrally extending from the third main body portion; the fourth metal plate comprises a fourth main body portion and a fourth soldering portion integrally extending from the fourth main body portion; the first soldering portion and the second soldering portion are arranged opposite to each other; the third soldering portion and the fourth soldering portion are arranged opposite to each other; the first soldering portion, the second soldering portion, the third soldering portion and the fourth soldering portion are enclosed to form a shielding space;
the first conductive terminal comprises a first tail portion protruding beyond the insulating block; the second conductive terminal comprises a second tail portion protruding beyond the insulating block; and the first tail portion and the second tail portion are at least partially located in the shielding space.

10. The electrical connector according to claim 1, wherein the first conductive terminal comprises a first contact portion protruding beyond the insulating block; the second conductive terminal comprises a second contact portion protruding beyond the insulating block; and both the first contact portion and the second contact portion protrude into the shielding cavity.

11. The electrical connector according to claim 3, wherein the third metal plate comprises a third main body portion, a first insertion portion connected to one end of the third main body portion, and a second insertion portion connected to another end of the third main body portion;
the fourth metal plate comprises a fourth main body portion, a third insertion portion connected to one end of the fourth main body portion, and a fourth insertion portion connected to another end of the fourth main body portion;
the mounting frame is provided with a first wall portion and a second wall portion disposed opposite to the first wall portion; the first wall portion defines a first mounting groove and a third mounting groove; the second wall portion defines a second mounting groove and a fourth mounting groove;
the first insertion portion is inserted in the first mounting groove, the second insertion portion is inserted in the second mounting groove, the third insertion portion is inserted in the third mounting groove, and the fourth insertion portion is inserted in the fourth mounting groove.

12. The electrical connector according to claim 11, wherein the first insertion portion is provided with a first locking tab protruding towards the third insertion portion; the second insertion portion is provided with a second locking tab protruding towards the fourth insertion portion; the third insertion portion is provided with a third locking tab protruding towards the first insertion portion; the fourth insertion portion is provided with a fourth locking tab protruding towards the second insertion portion; and the first locking tab, the second locking tab, the third locking tab and the fourth locking tab are configured to lock with the mounting frame.

13. The electrical connector according to claim 1, wherein the mounting frame comprises an inner frame and an outer frame, the inner frame and the outer frame are separately formed, and the inner frame is disposed in the outer frame.

14. The electrical connector according to claim 13, wherein the inner frame is an insulating inner frame, and the outer frame is a metal outer frame.

15. The electrical connector according to claim 1, wherein the mounting frame comprises a base plate portion, and the base plate portion defines a module receiving hole corresponding to the shielding cavity and communicating with the shielding cavity.

16. A connector assembly, comprising:
an electrical connector, the electrical connector comprising:
a mounting frame defining a mounting space;
a shielding shell assembly at least partially received in the mounting space; the shielding shell assembly comprising a first shielding plate assembly, a second shielding plate assembly, a third shielding plate assembly, and a fourth shielding plate assembly; the first shielding plate assembly and the second shielding plate assembly being arranged opposite to each other; the third shielding plate assembly and the fourth shielding plate assembly being arranged opposite to each other; two ends of the first shielding plate assembly being coupled to the third shielding plate assembly and the fourth shielding plate assembly, respectively; two ends of the second shielding plate assembly are coupled to the third shielding plate assembly and the fourth shielding plate assembly, respectively; the first shielding plate assembly, the second shielding plate assembly, the third shielding plate assembly and the fourth shielding plate assembly jointly forming a shielding unit, and the shielding unit defining a shielding cavity; and
a terminal module at least partially received in the shielding cavity, the terminal module comprising an insulating block, a first conductive terminal disposed on the insulating block, and a second conductive terminal disposed on the insulating block; and
a mating connector, the mating connector comprising a cable module and a metal shield enclosure sleeved over the cable module; the metal shield enclosure being at least partially received in the shielding cavity; and the metal shield enclosure being in contact with at least one of the first shielding plate assembly, the second shielding plate assembly, the third shielding plate assembly, and the fourth shielding plate assembly.

17. The connector assembly according to claim 16, wherein the two ends of the first shielding plate assembly are fixed to the third shielding plate assembly and the fourth shielding plate assembly, respectively, by soldering or welding; the two ends of the second shielding plate assembly are fixed to the third shielding plate assembly and the fourth shielding plate assembly, respectively, by soldering or welding.

18. The connector assembly according to claim 16, wherein the first shielding plate assembly comprises a first metal plate, the first metal plate comprises a first main body portion, and the first main body portion comprises a first protruding portion and a second protruding portion;
the second shielding plate assembly comprises a second metal plate, the second metal plate comprises a second main body portion, and the second main body portion comprises a third protruding portion and a fourth protruding portion;
the third shielding plate assembly comprises a third metal plate, and the third metal plate defines a first receiving groove and a third receiving groove;
the fourth shielding plate assembly comprises a fourth metal plate, and the fourth metal plate comprises a second receiving groove and a fourth receiving groove;
the first protruding portion is inserted in the first receiving groove, the second protruding portion is inserted in the second receiving groove, the third protruding portion is inserted in the third receiving groove, and the fourth protruding portion is inserted in the fourth receiving groove.

19. The connector assembly according to claim 18, wherein the first metal plate comprises a first soldering portion integrally extending from the first main body portion; the second metal plate comprises a second soldering portion integrally extending from the second main body portion; the third metal plate comprises a third main body portion and a third soldering portion integrally extending from the third main body portion; the fourth metal plate comprises a fourth main body portion and a fourth soldering portion integrally extending from the fourth main body portion; the first soldering portion and the second soldering portion are arranged opposite to each other; the third soldering portion and the fourth soldering portion are arranged opposite to each other; the first soldering portion, the second soldering portion, the third soldering portion and the fourth soldering portion are enclosed to form a shielding space;
the first conductive terminal comprises a first tail portion protruding beyond the insulating block; the second conductive terminal comprises a second tail portion protruding beyond the insulating block; and the first tail portion and the second tail portion are at least partially located in the shielding space.

20. The connector assembly according to claim 18, wherein the third metal plate comprises a third main body portion, a first insertion portion connected to one end of the third main body portion, and a second insertion portion connected to another end of the third main body portion;
the fourth metal plate comprises a fourth main body portion, a third insertion portion connected to one end of the fourth main body portion, and a fourth insertion portion connected to another end of the fourth main body portion;
the mounting frame is provided with a first wall portion and a second wall portion disposed opposite to the first wall portion; the first wall portion defines a first mounting groove and a third mounting groove; the second wall portion defines a second mounting groove and a fourth mounting groove;
the first insertion portion is inserted in the first mounting groove, the second insertion portion is inserted in the second mounting groove, the third insertion portion is inserted in the third mounting groove, and the fourth insertion portion is inserted in the fourth mounting groove.
